(19) United States
(12) Patent Application Publication
(10) Pub. No.: US 2014/0213339 A1
(43) Pub. Date: Jul. 31, 2014

(54) CHARITABLE GAMING

(71) Applicant: Zaki Khal, Henderson, NV (US)

(72) Inventor: Zaki Khal, Henderson, NV (US)

(21) Appl. No.: 14/167,247

(22) Filed: Jan. 29, 2014

Related U.S. Application Data
(60) Provisional application No. 61/758,960, filed on Jan. 31, 2013.

(51) Int. Cl. G07F 17/32

(52) U.S. Cl. CPC G07F 17/3244
USPC 463/19; 463/25; 463/18

(57) ABSTRACT

The invention relates to charitable gaming, and particularly the association of a player's wagering game play with one or more charitable entities. Other aspects of the invention comprise grouping of players with charitable entities and the allocation of gaming sessions, such as periods of time, with one or more charitable entities.

### RELATED APPLICATION DATA

This application claims priority to U.S. Provisional Patent Application No. 61/758,960, filed on Jan. 31, 2013.

### FIELD OF THE INVENTION

The present invention involves creating a networked wagering system that offers games of chance. This could potentially eliminate many of the operational tasks involved in the charitable operation of bingo games and enable many more charities to engage in bingo activities to raise funds. The process of achieving this migration raises many new challenges and processes that would need to be addressed. The advantage of a web based solution is that these challenges and processes only have to be addressed once and are then handled on an ongoing basis by the technology.

### BACKGROUND OF THE INVENTION

The laws of most states in the United States have provisions that allow charitable organizations to operate bingo, raffles, scratch cards, pull tabs, casino nights and other games of chance as a means of raising money. These laws generally limit the hours of operation, number of sessions allowed, prizes, and other operating parameters. The nature of these limitations generally makes it economically unfeasible for a charitable organization to lease a facility for the operation of bingo as the sole purpose. Charitable organizations have adapted to this environment by banding together to share the operating expenses of obtaining a physical location. It is not uncommon for 8 to 12 charities to share a single physical location. One charity might operate the bingo session on Thursdays at 7 p.m., while another charity might operate the 9 p.m. session later that night.

While this method of operation helps create financially viable charitable bingo operations, it does little to offset the many operational issues that have to be addressed before they can commence operations. Below are some of the initial and ongoing tasks that have to be performed by charitable operations:

1. Apply for and obtain the requisite licenses required by each jurisdiction.

2. Gauge anticipated customer traffic and expenditures to set appropriate prize levels.

3. Marketing the bingo operation to supporters of the charity.

4. General market advertising.

5. Design a bingo program with various types of games and prize levels along with scratch cards, pull tabs, raffles, and casino nights.

6. Obtain appropriate bingo paper, bingo daubers, and electronic bingo units, paper stock, and equipment.

7. Obtain volunteers to operate the games.

8. Obtain management to handle the reporting and accounting of bingo activity.

9. Train volunteers in the operation of the bingo systems including point of sale systems, electronics, accounting and winner verification processes.

10. Manage inventory and ordering supplies.

11. Maintain equipment, facility, and systems.

### SUMMARY OF THE INVENTION

Aspects of the invention comprise methods of playing and presenting games, gaming machines for presenting games, and gaming systems.

Further objects, features, and advantages of the present invention over the prior art will become apparent from the detailed description of the drawings which follows, when considered with the attached figures.

### DESCRIPTION OF THE DRAWINGS

FIG. 1 illustrates an embodiment of a gaming machine.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise methods of playing and presenting games, gaming machines for presenting games, and gaming systems. Preferably, the invention relates to charitable gaming, and particularly the association of a player's wagering game play with one or more charitable entities.

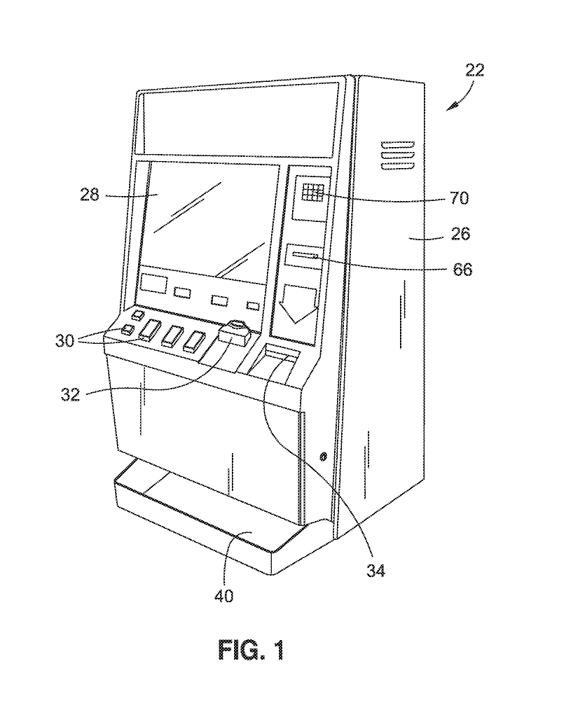

One embodiment of a gaming machine 22 will be described with reference to FIG. 1. The gaming machine 22 may be located at a casino, bingo room or parlor, or other location (and as such may be referred to as a “casino gaming machine”). As described below, the gaming machine 22 may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game information to be displayed on the at least one display 28. The controller may accept input from a player of game inputs via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

In another embodiment, the gaming machine 22 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 10, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, as described below, it is possible for the game of the invention to be presented on “presentation devices.” Such a presentation device may comprise a computing device, including at a home or office computer or a player's mobile electronic device such as a PDA, phone or the like. In one embodiment, a player might log into a wagering system or onto a wagering server which may cause game information to be delivered to the player's presentation device via a communication link and then be displayed on a display of the player's presentation device.

The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's presentation device. The local controller at the gaming machine or the player's computer or other electronic device may then cause game information to be displayed on one or more associated displays.

A casino may have numerous gaming machines 22, such as located on a casino floor or in other locations. Of course, such gaming machines 22 might be used in other environments, such as an airport, a bar or tavern, bingo hall, or other locations.

In one embodiment, a gaming system comprises one or more gaming machines 22 and/or one or more presentation devices, at least one gateway, and at least one wagering system.

As indicated above, each presentation device may be a dedicated/special purpose device or may be a general purpose device. Preferably, the presentation devices include at least one video display capable of displaying game information, at least one player input device, and at least one communication interface. As described herein, a presentation device might comprise, for example, a desktop computer, a laptop computer, a cellular phone or a PDA. As described above, the presentation device might comprise, for example, a desktop computer, a telephone (including cellular, wireless or wired telephones) or PDA (such as an iPhone®), a laptop or notebook computer, or various other devices. As indicated, the presentation device might also comprise a special purpose device such as a specially configured gaming tablet.

The player input device might comprise, for example, a keyboard, mouse, joystick, touch-screen, button(s), track-balls or other devices now known or later configured and which are capable of receiving input from a player. The communication interface is preferably configured to permit information or data to be exchanged from one or more remote device or locations with the presentation device. The one or more communication interface might support wired or wireless communications using various protocols.

The presentation device may include other components. For example, the presentation device may include a main processor, a video and/or audio processor, input and output ports or the like.

In one embodiment, at least one gateway preferably comprises one or more devices which are configured to link one or more presentation devices or gaming machines with a wagering system, such as to receive a request for game play by a player of a gaming machine or other presentation device. In a preferred embodiment, the gateway comprises one or more servers or communication interfaces. In such an embodiment, the gateway might comprise a server which is configured as a computing device which has a processor for executing instructions, a memory for storing data such as instructions, and at least one communication interface for forming a communication link to both at least one presentation device and a wagering system.

In one embodiment, the gateway might comprise or be in communication with one or more mass data storage devices, such as one or more hard drives or the like. The gateway might also include one or more user interface features. Such might comprise, for example, a user station which includes a video display and one or input devices (such as a keyboard, mouse or the like). Such a user station may permit an operator to interface with and manage or control the gateway, such as to change operator settings and the like.

It will be appreciated that the gateway might comprise more than one device. For example, the gateway might comprise a router and one or more separate computing devices. The functions of the various computing devices might be segregated. For example, one computing device might save and verify login information, while another might monitor game play via the wagering systems.

The outcome of games may be determined at the gaming machines and/or presentation devices (in which case, as described below, the outcomes of those games and/or other game information may be reported from those gaming machines or presentation devices to the wagering system, such as for tracking purposes). In other embodiments, the wagering system is preferably configured to generate game information, transmit game information, receive player input, and generate game outcomes. At one or more times the wagering system is in communication with the gateway, whereby the wagering system may receive information from the gateway and may transmit information to the gateway. The wagering system generally determines game results by the use of a random number generator. In other embodiments, game results may be determined by the results of a future event, a ball draw device, a deck of cards, a random selection of a prior event, a video representation of a live event, or other random methods.

In accordance with the invention, each wagering game or session is assigned a unique identification number. The gateway or a device linked thereto may store player identification information. A player presentation device or gaming machine transmits identification information to the gateway for verification. If positively verified, a communication link is established through the gateway from the presentation device or gaming machine to the gaming system. In this manner, each player's games or gaming session is unique assigned or tracked.

In one embodiment, a plurality of wagering systems may be linked to one or more gateways. For example, multiple charities might operate wagering systems that are available at approximately the same time.

In one embodiment, as players change to a different wagering system that is operated by different charity, players are notified of the change and allowed to make a choice as to whether to continue. In this manner, players are always conscious of which charity is benefiting from their gaming activity.

In a preferred embodiment, one or more of the games presented to a player by their assigned wagering system is a game of chance or wagering game. The gateway, wagering system/server, or a linked accounting system may facilitate recording each transaction such as wagers, game results, and account balance.

Embodiments of the invention comprise methods and systems for presenting games of chance or wagering games, including blackjack, poker, baccarat, other playing card games, race, sports, keno, bingo, pull tabs, scratch cards, raffles or lotteries, which games may be presented on-line, or via a gaming or slot machine.

As described in more detail below, at one or more times a presentation device and the gateway are linked by a communication link between their communication interfaces. The type of communication link may vary, such as depending upon the particular type of presentation device and/or the communication path or protocol which is utilized.

In one embodiment, the presentation device and gateway may communicate through at least one external network. Such a network might comprise the Internet, a cellular network, a satellite communication network or the like. Of course, the communication link might comprise a dedicated link, such as a dedicated wired link between the devices. Further, the communication link might comprise a number of local, wide area or other networks or pathways linked together. Such networks might be public and/or private.

Gaming machines may be similarly linked to the wagering system via a gateway or directly to the wagering system. In other embodiments, it is possible for the gateway to be integral to the wagering system, such as a communication interface of a wagering server.

The wagering system is preferably configured to generate game information, transmit game information, receive player input, and generate game outcomes. As indicated above, the wagering system is in communication with the gateway, whereby the wagering system may receive information from the gateway and may transmit information to the gateway.

In one embodiment, the wagering system comprises a computing device such as a server, computer or circuit board. As indicated, the wagering system is configured to generate and/or track game information. In one embodiment, the wagering system comprises means for generating game data or information and/or storing game data or information. Such means may comprise at least one processor. The processor is configured generate game information, such as based upon the execution of machine readable game code (i.e. software). Of course, the processor could also be pre-programmed or configured as hardware configured to generate such game data.

In one embodiment, the wagering system includes means for storing game code or instructions. Such means may comprise one or more memory devices. Such might comprise RAM, ROM (including EPROM, EEPROM, PROM) or other devices now known or later developed. The wagering system might include one or more other memory device, such as for storing game state information or the like, as detailed below.

When the wagering system is configured to generate game outcome information, the wagering system includes at least one random number generator (whether configured as software or hardware) or other similar device. Such a generator is preferably utilized as part of the game code to generate random game outcomes. Such components/features are well known to those of skill in the gaming art. In other embodiments, the game outcome could be determined by an external event such as a ball draw device, a deck of cards, a random selection of a prior event, a video representation of a live event, a roulette wheel, or other random methods.

The wagering system preferably also comprises at least one communication device or interface to permit data to be provided to the wagering system and to permit data to be transmitted from the wagering system to one or more remote device. Such might comprise a communication interface. Once again, the configuration of the communication interface might depend upon the particular type of communications to be utilized (wired or wireless) and the protocols.

Via the wagering system, games may be presented to players of gaming machines and/or presentation devices (such as via connection to such devices via the gateway). Also, the wagering system is configured to track games played by players of gaming machines or presentation devices (such as relative to games where the results are determined by those machines or devices, rather than the gateway).

In one embodiment, each wagering game or session is uniquely identifiable, such as by a unique serial or other identification number, port or other location. As described in greater detail below, each wagering session is assigned to a particular player or entity, whereby only that player or entity can interface with the wagering system and play games presented by that wagering system.

Thus, a first player 1 may have a first wagering session A assigned or registered to them. A second player 2 may have a second wagering session B assigned or registered to them.

The first player 1 might access their assigned wagering system A via first presentation device, such as their home desktop computer. As described in greater detail below, the first player may contact the gateway and, subject to identity verification, be placed in communication with their assigned wagering session A.

Likewise, second player 2 might access their assigned wagering session B via a second presentation device, such as their laptop computer. The second player may contact the gateway and, again subject to identity verification, be placed in communication with their assigned wagering session B.

As indicated above, numerous wagering games or sessions may be provided, wherein each wagering game or session is assigned or registered to a particular player or entity.

The games presented by the wagering system(s), gaming machines or presentation devices may be wagering type games wherein a player must place a bet or wager in order to play the game for the opportunity to receive winnings. Preferably, if the player is a winner of the game, the player is provided an award, such as a monetary payout (such as coins), credits representing monetary value, points or tangible prizes.

The gaming system might also include one or more player tracking systems or servers, accounting systems or servers, etc. For example, one or more player tracking servers (which are preferably in communication with the wagering system) might track player play. For example, a charity or other game provider may have a player loyalty club. Each player may be uniquely identified and information regarding the player, including their game play, may be stored in one or more data files. Based upon a player's play, such as amounts wagered, lost, won, time of play or various other criteria, a charity may award a player bonus or free play.

Of course, the wagering systems and/or one or more gateways may be in communication with or otherwise link to other devices and systems.

Various aspects of the invention comprise methods of presenting and playing wagering games. Aspects of such methods will now be described.

As one aspect of the invention, a wagering game or session is assigned or registered to a particular player or entity. As described below, this permits a player's game play to be tracked or logged to a particular charitable entity or the like.

In one method, in a step S1, a player or other entity is registered. This may comprise obtaining information which identifies the player, such as their name, address, social security number, telephone number, email address or the like. Such a registration may be the same as the registration process for joining the charity's existing loyalty club. As such, in some embodiments, the first step S1 may be accomplished as part of a player's earlier or existing registration with such a club.

In one embodiment, one or more data files may be generated and data may be stored with those files. For example, a data file may be generated relative to the player and the player identification information may be stored in the file.

In a step S2, a wagering game or session is assigned to the player. As part of this step, the method may include determining which wagering games or sessions are available for based on the time, date, and jurisdiction. In one embodiment, information regarding the wagering game or session is associated with the player. For example, a serial number or other identifier of the wagering game or session may be linked to the player's information.

In a step S3, a login or other access information may be provided to or associated with the player. For example, a player may be assigned a User ID and/or an access password, or the player might be permitted to select such (of course, criteria for the User ID and password, such as the format thereof, such be selected by the game operator and the User ID and password may be subject to clearance, such as to ensure that different players do not select the same information). As indicated below, such information may be used by a player to identify them and access their wagering session.

As indicated above, such information may be stored in one or more data files, tables or the like. Such a table might be stored, for example, at the one or more wagering systems or one or more data storage devices associated with the one or more wagering systems, or other devices, such as a player tracking server.

It will be appreciated that the above-referenced method may be implemented in various manners. In a preferred embodiment, the registration process might be accomplished by a player's presentation device. For example, a player might utilize a desktop computer to access a website of the charity on the Internet. The casino's website might have a registration utility which causes a graphical user interface or the like to be displayed upon the player's computer and via which the registration process may be completed.

In one embodiment, the wagering systems may establish a communication link with one or more servers that perform centralized processing and verification of player information such as player identity, player age, player's geographic location, name, address, social security number and account funding and withdrawal mechanisms. Such one or more centralized systems may provide wagering systems with player information required for reporting and processing purposes. As an example, the centralized system might provide the players name, address and social security information for completion of a W2G to report certain gaming winnings. In one embodiment, this server may be part of the gateway.

In accordance with one embodiment of a method, a player provides access or login information. Preferably, such comprises the player providing information which identifies the player, as in a step S4. In one embodiment, this may comprise the player's User ID and password.

This step may be accomplished in various ways. For example, a charity may provide a website on the Internet. The player may access that website via their presentation device. The website may include a link, such as “Login” link. Upon clicking that link, a page or interface may be displayed to the player which requests their login information (such as providing a box or field for the player to input their User ID and another box or field into which the player may insert their password). The player might also provide such information at a gaming machine, such as by inputting a player tracking card, by keying in information to a keypad or the like.

In a step S5, the player's identification or login information is verified. This may comprise, for example, comparing the user's User ID and password to those stored in the one or more data files. If no match is found, the player may be notified of such and the login process may either be terminated or the player may be requested to re-input their information again for verification, as in step S6.

In a step S7, if the player's identification is verified, the player is linked to the wagering system. For example, if the player “Jimmy the Greek” has correctly identified himself with the appropriate User ID and password, then he may be linked to the wagering system.

Once the player is linked to the wagering system, the wagering system may present, and the player may play, one or more games as in step S8. As indicated herein, this may comprise the wagering system generating game information, including data representing video images, game outcomes or the like. This data is transmitted from the wagering system to the player's presentation device, such as through the gateway. Alternatively, this may comprise the gaming machine or presentation device generating game outcomes and presenting games to the player and then reporting those outcomes to the wagering system (so that they may be tracked by the wagering system).

Of course, various games may be presented to the player. In one embodiment, the wagering system may cause a graphical user interface to be displayed by the player's presentation device. That interface may permit the player to select different games for play, change play options or engage in other activities. For example, the player might be permitted to pick from games offered by certain charities, by certain types of charities, a suite of different video slot games and/or video poker, keno, bingo or other games now known or later developed.

A player may provide input, such as via a touch screen of their presentation device or the gaming machine, of a particular game to be played. The wagering system begins the game, including by transmitting game information back through the gateway to the player's presentation device. Such game information may comprise, for example, a video game display which illustrates images of slot reels and other information, cards or the like (depending on the game being presented).

Depending on the game being presented, the player may be required to provide various inputs and various information may be displayed to the player. For example, in a game of video poker, the player may be shown a set of dealt cards and then select one or more or all of the cards to be held and/or discarded.

In one embodiment, the player may be required to deposit monies with the game provider, such as into an account which is associated with the player. For example, the player might deposit cash or provide a credit or debit card which is used to transfer an amount of funds, such as $500.00, to the player's account. Those funds may be represented by credits, such as 2000 credits where each credit has a value of $0.25, or 500 credits each having a value of $1.00.

In other embodiments, the player might provide value when the game is to be played. For example, the wagering system might prompt the player to provide value account information, such as information regarding a credit or debit card. The player might provide such information via their presentation device or the gaming machine. The gateway might transfer such information to one or more external servers, such as an accounting server. The accounting server may communicate with a banking system or the like to affect a transfer of funds from the player's bank or credit account to an account belonging to the game provider.

In one embodiment, a player may then make a selection of the amount to wager as part of the play of a game. In one embodiment, a player may even be permitted to select the wager denomination for the game. For example, a game may require that the player place a minimum wager of 1 credit up to a maximum wager of 5 credits. However, the player may be permitted to select the denomination of each credit, such as $0.01, $0.05, $0.10, $0.25, $1.00 or other values.

Once the player makes their wager selection, the wagered value may be deducted from their casino account, bank account or the like or may be charged to their credit card and held as a wager pending the outcome of the wagering event. Once the outcome of the wagering event has been determined, winnings are added to the player account or the losses are deducted from the pending wager account balance. In one embodiment, once the wager has been verified (such as by a signal from the accounting server to the gateway and on to the wagering system), the wagering system may present the game.

As indicated, one or more (but preferably not all) of the possible outcomes of the game may be designated as winning outcomes. One or more of the winning outcomes may have an associated award, such as an award of one or more credits. The number of credits for particular winning outcomes may vary, such as defined by a pay table for the game.

If a player receives a winning outcome having an associated award, the player is preferably credited with such an award, such as the number of credits. The credits may be credited to the player's wagering account, for example. In other embodiments, the credits may be aggregated during game play and at one or more times the player may elect to “cash out” by having the monetary value represented by those credits be transferred to the player's bank account.

As one aspect of the invention, players might be linked or grouped. There are several different methods that might be employed to group players together on the system:

1. Players could be grouped together according to the charity for which they are playing.

2. Players that are playing the same or different games with different charities could be grouped together to form larger groups of players for social interaction and other purposes.

3. Players that are playing the same or different games could be grouped together from different geographical areas or jurisdictions.

4. Players from the same geographical area or jurisdiction could be grouped together even though they might be playing different games with different charities or operators.

5. Players from jurisdictions that have similar laws could be grouped together. As an example, players that are participating in a wide area progressive or other common game could be grouped together.

6. Players from jurisdictions that enable interstate wagering could be grouped together.

7. Players that are playing the same game, such as a coverall, letter X, other pattern, raffle, pull tab, or casino night might be grouped together. For example, players that are playing with different charities or operators could be grouped together because they are all playing a coverall bingo game.

8. Players that are playing different games, such as a coverall, letter X, other pattern, raffle, pull tab, or casino night might be grouped together.

9. Players that are playing on the same game results could be grouped together.

10. Players that are playing on different game results could be grouped together.

11. Players could be grouped together based on the prize amounts for which they are playing even though they are playing different games

12. Players that are playing for different prizes could be grouped together. For example, players could be playing the same game, yet be playing for different prize amounts based on the amount wagered.

13. Players playing from physical facilities could be grouped together with those playing from the web. For example, players who are at home could be linked together with players in bingo halls or casinos.

14. Players that are playing for certain types of charities such as animal, environmental, health or educational charities

Additionally, any combination of the types of grouping noted above may be employed. As an example, players from different charities could be in the same effective room for ball draw and or social chat purposes, yet be playing for different charities, bingo patterns, and prizes. To further explain the grouping methods noted in #9 and #10, for a bingo game each charity group might use the same or separate independent bingo ball draws to determine the results of the game. For a game with multiple independent bingo ball draws the winner or winners could be determined by the first player to achieve a winning pattern in the least number of balls drawn among the various groups. There are many other possible combinations and groupings.

The level of wagering activity both in terms of the number of players and the amount wagered may vary substantially during the course of a day, week, month, or year. The wagering sessions, or periods of times during which a charity operates a game or series of games, on the system may be indexed and ranked. This would enable an allocation of days and times of operations between charities based on the revenue or profit to provide more equitable opportunities to each participating charity. The table below illustrates relative business levels by day and time.

| Time | Sunday | Monday | Tuesday | Wednesday | Thursday | Friday | Saturday |
|---|---|---|---|---|---|---|---|
| 12:00 | 1.64331 | 0.82280 | 1.63289 | 1.62487 | 1.52014 | 1.22739 | 1.04528 |
| 13:00 | 1.75822 | 1.99549 | 0.55022 | 0.75722 | 0.52117 | 1.49957 | 0.17142 |
| 14:00 | 1.28031 | 1.43989 | 1.58576 | 1.54993 | 1.81139 | 1.57982 | 1.02599 |
| 15:00 | 1.05148 | 0.36036 | 0.60288 | 0.40163 | 0.87721 | 0.54486 | 1.57059 |
| 16:00 | 1.21851 | 0.83014 | 0.31798 | 0.96438 | 0.63237 | 0.02683 | 1.71167 |
| 17:00 | 1.47839 | 1.32788 | 0.84450 | 0.41948 | 0.59972 | 0.69330 | 1.02145 |
| 18:00 | 1.15643 | 1.91033 | 0.12075 | 1.99201 | 0.29881 | 0.17407 | 0.30952 |
| 19:00 | 1.90038 | 0.56441 | 0.89197 | 0.54302 | 0.78560 | 1.16940 | 0.38613 |
| 20:00 | 0.36864 | 0.65161 | 0.12344 | 1.57856 | 0.93430 | 0.30260 | 1.68935 |
| 21:00 | 1.07450 | 0.06907 | 1.82567 | 0.79487 | 0.90292 | 1.45828 | 0.67889 |
| 22:00 | 1.57609 | 0.31671 | 0.83143 | 1.75828 | 1.23145 | 0.01109 | 1.31534 |
| 23:00 | 0.74663 | 0.92962 | 1.29666 | 0.40006 | 1.05458 | 1.88760 | 0.03165 |
| 0:00 | 1.88256 | 0.88133 | 1.74231 | 1.09743 | 0.41139 | 1.93070 | 1.09346 |
| 1:00 | 1.79691 | 1.30940 | 1.35416 | 0.87722 | 1.80422 | 0.18415 | 0.06841 |
| 2:00 | 1.59684 | 1.59367 | 1.85350 | 0.87646 | 0.87060 | 0.47872 | 0.40216 |
| 3:00 | 0.48475 | 0.26401 | 0.18661 | 0.15085 | 1.33472 | 1.94890 | 0.26566 |
| 4:00 | 1.29401 | 1.68872 | 0.57575 | 1.15448 | 0.97882 | 0.60430 | 1.31911 |
| 5:00 | 0.01648 | 0.79329 | 0.43172 | 0.57762 | 1.94727 | 1.03204 | 1.25078 |
| 6:00 | 1.06159 | 1.16340 | 0.22002 | 1.32790 | 0.22387 | 1.21455 | 1.02686 |
| 7:00 | 0.99856 | 0.65997 | 0.59324 | 1.00976 | 1.84681 | 0.65884 | 1.76828 |
| 8:00 | 1.88645 | 0.66026 | 1.50214 | 0.26413 | 0.02646 | 0.33855 | 0.66175 |
| 9:00 | 0.79017 | 0.53551 | 1.76460 | 1.47109 | 1.79965 | 0.64825 | 1.53485 |
| 10:00 | 1.37192 | 0.96614 | 0.77427 | 0.73362 | 1.94264 | 0.16097 | 0.07671 |
| 11:00 | 1.00332 | 1.45089 | 0.45393 | 0.30510 | 0.96813 | 0.98359 | 1.79132 |

The average of the indexes listed is 0.98553. Relative business levels as depicted above may be computed for varying periods of time such as weekly, monthly, quarterly, annually, trailing 12 months, and other periods. The times note above are purely illustrative of game sessions that last approximately one hour. It is possible to have game sessions that last only seconds, while others may last several days, and anything in between. Additionally, similar indexes may be computed by type of game. This would enable computation of relative business levels based on the type of games offered.

As indicated above, some jurisdictions limit the number of sessions that are allowed. For example, consider a jurisdiction in which each charity is allowed to operate four one hour sessions per week. One could simply start trying to find combinations of 4 of the indexes that are as close as possible to the average noted above. Alternatively, a linear programming model could be set up but listing all the combinations, over 32 billion, would be complicated and computing the results would take considerable time. One could also try a random assignment but that might take considerable time to balance out. Below is sample algorithm for balancing revenue opportunities among charities.

1. Add the two highest unassigned values to the lowest value.

2. Subtract the sum from #1 from the 4 times the average index value.

3. Find the remaining unassigned value that is closest to the difference computed in #2.

4. Group the four values from #1 and #3 for one charity and mark them as having been assigned.

5. Add the two lowest values remaining unassigned values to the highest remaining value.

6. Subtract the sum from #5 from the 4 times the average index value.

7. Find the remaining unassigned value that is closest to the difference computed in #6.

8. Group the four values from #5 and #7 for one charity and mark them as having been assigned.

9. Repeat the process until all values have been assigned.

This algorithm could just as well begin by taking the two lowest values and modifying #5 to the highest values. By eliminating the highest and lowest values at the beginning of the process, this algorithm should improve the propensity for a balanced schedule. This balancing algorithm may be applied to other process unrelated to the main context of this invention.

A similar algorithm for selecting an odd number of sessions or units would simply start with the highest or lowest values and continue accordingly as noted below:

1. Add the highest and lowest unassigned values.

2. Subtract the sum from #1 from the 3 times the average index value.

3. Find the remaining unassigned value that is closest to the difference computed in #2.

4. Group the three values from #1 and #3 for one charity and mark them as having been assigned.

If there are extra sessions that need to be assigned they may be allocated based on the relative indexes computed above or actual business level indicators such as number of players, wagers made, gross profit, net profit, etc.

Players might be allowed to allocate their playing activity among different charities in several different ways:

1. Days of the week;

2. Weeks of the month;

3. Months of the year;

4. A percentage allocation between multiple charities;

5. The first $X dollars going to one charity, the next $N dollars going to a different charity, and so on;

6. Types of charities such as cancer research, child care, or disability charities; and

7. Randomly assigned.

These methods of allocation may also be combined. As an example, a player might choose to have 80% of his wagering activity to go to Big Brothers and Big Sisters during the first half of the year with the balance going to the Make a Wish Foundation, and choose different contribution rates and charities for the second half of the year.

A player that is introduced to the wagering portal by a charity may elect to have loyalty over rides paid to the charity or charities he has selected as noted above. Once a player has made this selection, his favorite charity or charities would receive a share of his gaming activity, either a fixed amount or a percentage, on games conducted by other charities. As an example, if a player has chosen Save the Children as his favorite charity and then plays a game conducted by the Make a Wish Foundation, 6% of his wagers would be allocated as donations to Save the Children. This loyalty fee is an operating expense to the charity conducting the game and a donation to the charity receiving the fee.

In some games such as keno, bingo, and some slot machine implementations players generally purchase the opportunity to play in multiple games at the start of a session, or series of games. Players could be allowed to purchase games as follows:

1. The complete series of games offered during a session.

2. The next game to be played.

3. The next N games to be played.

4. A future game to be played.

5. The future X games to be played beginning on the Nth future game.

There are different methods that might be employed to offer prizes when multiple charities are grouped together in one or more of the grouping methods noted earlier:

1. A game might offer the same consolation prize with the same ticket cost;

2. A game might offer the same consolation prize with different ticket costs;

3. A game might offer different consolation prizes with the same ticket cost;

4. A game might offer different consolation prizes with different ticket costs;

5. A game might offer a shared consolation prize that is based on a percentage of the tickets issued;

6. A game might offer different intermediate prizes and have one of the consolation variations noted above; and

7. A game might offer the same intermediate prizes and have one of the consolation variations noted above.

As an illustration, an example of the consolation cost allocation for a game with different ticket prices and different prizes is depicted below:

| Charity | A | B | C | Total |
|---|---|---|---|---|
| Ticket Price | $ 2.00 | $ 1.00 | $ 1.00 | |
| Consolation | $300.00 | $200.00 | $100.00 | |
| % of Consolation | 50.0% | 33.3% | 16.7% | 100.0% |
| Ticket Sales | 200 | 150 | 125 | 475 |
| % of Tickets | 42.1% | 31.6% | 26.3% | 100.0% |
| % of Cons. X % Ticket Sales | 21.1% | 10.5% | 4.4% | 36.0% |
| Consolation Allocation | 58.5% | 29.3% | 12.2% | 100.0% |
| Charity | Cost Allocation | | | |
| Consolation Cost | A | B | C | Total |
| $100.00 | $ 58.54 | $29.27 | $12.20 | $100.00 |
| $200.00 | $117.07 | $58.54 | $24.39 | $200.00 |
| $300.00 | $175.61 | $87.80 | $36.59 | $300.00 |

This is one of the more complex schemes that are possible. In this example the cost allocation is based on an index of the product of the relative consolation prize that is offered times the percentage of tickets issued. These types of methods allow charities to share the cost of consolation prize while benefiting from the critical mass of players for social interaction and other purposes. Some of these grouping methods may be applied to games other than bingo.

The grouping prize methods mentioned above may be combined to form many different combinations. As an example in the cost allocation scheme above the charities might be from the same or multiple jurisdictions playing.

There are different methods of displaying the available games; by prize amount, type of game, cost to play, day, time, charity, players favorite charities, type of charity such as animal, health, environmental, educational, etc., and charities that are local to the player's geographical area. If a player wishes to play a game that is not being sponsored by one of his charities, he could be given a choice to have his play for that game assigned to the charity that is sponsoring the game, or make an allocation among some or all of the charities sponsoring the game.

In one embodiment, game play by a player is assigned or attributed to one or more charitable entities. In one embodiment, a charitable entity may receive value or the like for the player's game play. For example, in the event the outcome of a game is a losing game, the charitable entity might receive a portion of the player's wager. In the event the outcome of the game is a winning game, the charitable entity might receive one or more player tracking points, a smaller portion of the player's wager or the like. Preferably, the player's play of one or more games as “assigned” to the charitable entity results in the charitable entity receiving some benefit or value.

There are different ways of aggregating and reporting donations made to charities and gaming winnings on the wagering system:

1. If deposits to wagering accounts are non-refundable, all deposits to wagering accounts are treated and reported as tax deductible donations.

2. On a periodic basis the actual net difference between wagering losses and wins is reported as a tax deductible donation.

3. Actual amounts wagered and lost could be reported as charitable contributions.

4. Any reportable W-2G winnings are reported.

A unique aspect of this wagering system is the potential to make a charitable donation that is partially or completely refundable. If deposits to wagering accounts are treated as non-refundable, any gaming winnings would be tracked separately and become eligible for withdrawal or to be used as additional deposits.

In order to provide a seemingly continuous series of gaming opportunities, charities would be scheduled according to the rules for each game for each jurisdiction. As an example, if bingo games are only allowed to operate for one hour, a charity would be scheduled to run a game for an hour at a time followed by a new series of games offered by another charity. Other games, such as raffles, may run for several days. Several games such as those listed above could be run simultaneously.

Each state or jurisdiction may have specific rules such as hours of operation, game prize limits, session prize limits, annual prize limits, types of games that may be offered, administrative fee limits, number of cards in a deal or set of scratch of tickets or pull tabs, number of casinos night events that may be operated per year, daily limits, and annual limits. All of the operating parameters for each jurisdiction would be programmed into the site to ensure full compliance. Any jurisdictional licenses issued allowing the operation of the games would be linked to each gaming event and made available for viewing by players to further authenticate the charitable nature of the gaming activities. Achieving and maintaining a continuous online experience will require considerable organization, licensing and reporting. The wagering system will also include a compliance component for the licensing and reporting of wagering activity. The system will assign identifiers to different data fields for each licensee organization and its principals to allow automated completion of application forms and reports.

Gaming activity would be summarized for each charity by time, day, type of game, monthly, quarterly, annually and as otherwise needed for reporting for regulatory authorities. Any reports required by regulatory authorities would be produced by the system when possible for review and authorization by charity management.

Depending on the laws for each jurisdiction the system could be designed to have administrators set up a series of games for each charity which might then be reviewed and approved by charity officials. Charity officials or representatives could also be involved in the operation of the games on a real time basis by monitoring game activity, initiating the start of an event, initiating a game determination process such as a ball draw or raffle selection, announcing winners, etc.

The wagering system would automatically track and record the approvals for games for each charity, provide notice of expiration to administrators and charity officials, and automatically cease operation of games that do not have a valid license or permit.

What is claimed is:

1. A method of game play comprising:
receiving input from a player of a selected charitable entity from a set of charitable entities, said input received at a game presentation device;
receiving a wager from said player to play at least one wager-based game;
presenting game information regarding said wager-based game to said player via at least one electronic display of said game presentation device;
determining an outcome of said at least one wager-based game, wherein said outcome may be a winning outcome or a losing outcome;
if said outcome is a winning outcome, awarding an award to said player; and
if said outcome is a losing outcome, allocating at least a portion of said wager to funding said award and at least a portion to said selected charitable entity.

2. The method in accordance with claim 1 wherein if said outcome is a winning outcome allocating value to said charitable entity.

3. The method in accordance with claim 2 wherein said value comprises one or more player tacking points.

4. The method in accordance with claim 1 wherein said game presentation device is selected from the group consisting of: a PDA, a phone, a tablet and a computer.

5. The method in accordance with claim 1 wherein said set of charitable entities comprises a list.

6. The method in accordance with claim 1 wherein said presentation device comprises a gaming machine.

7. A game server by which multiple charitable organizations may present games to players comprising:
at least one game server comprising a processor configured to execute machine readable code;
at least one communication interface which permits said game server to communicate with a plurality of player presentation devices;
at least one data storage device configured to store information regarding game play;
machine readable code executable by said processor configured to cause said game server to generate game information regarding least one wagering game and to transmit said game information via said at least one communication interface to a first player of a first one of said player presentation devices and a second player of a second one of said player presentation devices;
machine readable code executable by said processor configured to cause said game server configured to receive wager information from said first player and said second player and associate said wager information with either a first charitable entity or at least one second charitable entity.

8. The game server in accordance with claim 7 wherein said game server is configured to present game information regarding a first wagering game to both said first player and said second player and is configured to associate wager information from said first player with said first charitable entity and wager information from said second player with a second charitable entity.

9. The game server in accordance with claim 7 wherein said game server is configured to present a first wagering game at a first time of day and a second wagering game at a second time of day and to associate wager information from said first and second players relative to said first wagering game with a first charitable entity and relative to said second wagering game with a second charitable entity.

10. The game server in accordance with claim 7 wherein said wagering game comprises bingo or keno.

11. The game server in accordance with claim 7 wherein said server is configured to receive input from said first player of a selected charitable entity and to associate wager information from said first player with said selected charitable entity.

12. The game server in accordance with claim 7 wherein said player presentation devices are selected from the group consisting of: a gaming machine, a phone, a tablet and a PDA.

13. The game server in accordance with claim 7 wherein said game server is configured to associate wager information from said first and second players with the same charitable entity if said first and second players are playing at the same location.

14. The game server in accordance with claim 7 wherein said game server is configured to associate wager information from said first and second players with the same charitable entity if said first and second players are playing the same game.
